(19) United States
(12) Patent Application Publication
(10) Pub. No.: US 2019/0273431 A1
(43) Pub. Date: Sep. 5, 2019

(54) DIGITAL CONTROL SYSTEM FOR VOLTAGE REGULATION AND METHOD THEREOF

(71) Applicant: NUVOTON TECHNOLOGY CORPORATION, Hsinchu City (TW)

(72) Inventors: Chung-Ming HSIEH, Hsinchu Science Park (TW); Wei-Chan HSU, Cupertino, CA (US)

(21) Appl. No.: 16/148,358

(22) Filed: Oct. 1, 2018

(30) Foreign Application Priority Data
Mar. 1, 2018 (TW) 107106765

(51) Int. Cl. H02M 3/07; H02M 1/44

(52) U.S. Cl. CPC H02M 3/07; H02M 2001/0012; H02M 1/44

(57) ABSTRACT

A digital control system for voltage regulation and a method thereof are disclosed. The digital control system includes an adjustable voltage regulation circuit having multiple discrete conversion ratios, an error generator, a digital controller and a conversion ratio controller. The adjustable voltage regulation circuit, the error generator, the digital controller and the conversion ratio controller form a closed loop control system. The adjustable voltage regulation circuit includes a conversion ratio controlling terminal receiving a conversion ratio signal. The error generator compares an output voltage of the adjustable voltage regulation circuit with a reference voltage to generate an error voltage, and the digital controller outputs a digital control signal to the conversion ratio controller according to the error voltage. The conversion ratio controller outputs the conversion ratio signal to the conversion ratio controlling terminal, so as to use one of the discrete conversion ratios to generate the output voltage.

### CROSS-REFERENCE TO RELATED APPLICATION

This application claims the benefit of Taiwan Patent Application No. 107106765, filed on Mar. 1, 2018, in the Taiwan Intellectual Property Office, the disclosure of which is incorporated herein in its entirety by reference.

### BACKGROUND OF THE INVENTION

### 1. Field of the Invention

The present invention generally relates to a regulation system, more particularly to a digital control system for voltage regulation using a digital control manner, and a method thereof.

### 2. Description of the Related Art

Because each electronic device has specific voltage requirements, a voltage regulator is usually disposed in the electronic device to adjust the voltage. Common regulators include buck regulators, booster regulators, and full-bridge regulators. Each of aforementioned regulators has switching components and generates the required voltage by adjusting switching periods of the switching components, such as a pulse width modulation scheme. However, a voltage adjustment range of the above-mentioned regulator is also limited by the switching period of the switch component.

Therefore, what is needed is to develop a digital control system for voltage regulation, to solve the above problems.

### SUMMARY OF THE INVENTION

In order to solve conventional problems, the present invention is to provide a digital control system for voltage regulation and a method thereof.

According to an embodiment, the present invention provides a digital control system for voltage regulation. The digital control system comprises an adjustable switch-capacitor power circuit with a plurality of discrete conversion ratios, an error generator, a digital controller and a conversion ratio controller. The adjustable switch-capacitor power circuit is electrically connected to the error generator, and then the error generator is electrically connected to the digital controller. The digital controller is electrically connected to the conversion ratio controller, and then the conversion ratio controller is electrically connected to the adjustable switch-capacitor power circuit. The digital control system for voltage regulation is a closed loop system to adjust voltage steady. The adjustment scope of the voltage is controlled by the conversion ratio signal instead of the switching period of the switch component. The adjustable switch-capacitor power circuit comprises an input terminal, a conversion ratio control terminal, and an output terminal, and the input terminal is configured to receive an input voltage, the output terminal is configured to output an output voltage, and the conversion ratio control terminal is configured to receive a conversion ratio signal. The adjustable switch-capacitor power circuit uses one of the plurality of discrete conversion ratios according to the conversion ratio signal, to convert the input voltage into the output voltage. The error generator is coupled to the output terminal, and configured to compare the output voltage and the external reference voltage, to obtain an error voltage and then transmits the error voltage to the digital controller. The digital controller is coupled to the error generator, and configured to receive the error voltage and output a digital control signal and then transmits the digital control signal to the conversion ratio controller. The conversion ratio controller is coupled between the adjustable switch-capacitor power circuit and digital controller, and configured to receive the digital control signal, and output the conversion ratio signal according to the digital control signal, to the adjustable switch-capacitor power circuit. The adjustable switch-capacitor power circuit selects one of the plurality of discrete conversion ratios to adjust output voltage based on the conversion ratio signal.

Preferably, the adjustable switch-capacitor power circuit is the fine resolution switch-capacitor power circuit.

Preferably, when the error voltage is higher than zero, the digital controller outputs, according to the error voltage, a digital control signal having a voltage decreasing message, and the conversion ratio controller outputs, according to the digital control signal having the voltage decreasing message, the conversion ratio signal with a lower multiplier.

Preferably, when the error voltage is lower than zero, the digital controller outputs, according to the error voltage, the digital control signal having a voltage increasing message, and the conversion ratio controller outputs, according to the digital control signal having the voltage increasing message, the conversion ratio signal with a higher multiplier.

Preferably, when the error voltage is equal to zero, the digital controller outputs the digital control signal having a voltage maintaining message, and the conversion ratio controller outputs the conversion ratio signal with a value of one.

Preferably, the adjustable switch-capacitor power circuit further comprises a sampling filter coupled between the output terminal and the error generator and configured to filter the output voltage, thereby reducing noise interference on the output voltage.

Preferably, the error generator comprises an analog-to-digital conversion component and a subtraction component, and the analog-to-digital conversion component is coupled to the sampling filter and configured to convert the filtered output voltage into a digital output voltage, and the subtraction component is coupled between the analog-to-digital conversion component and the digital controller and configured to subtract the external reference voltage from the digital output voltage, so as to obtain the error voltage.

Preferably, the conversion ratio controller comprises a conversion ratio selection table and a logic control component, and the conversion ratio selection table is connected to the digital controller and selects the conversion ratio signal according to the digital control signal, and the logic control component is coupled between the conversion ratio selection table and the conversion ratio control terminal, and configured to transmit the conversion ratio signal to the conversion ratio control terminal.

According to an embodiment, the present invention provides a digital control method for voltage regulation, and the digital control method comprises steps of: providing an adjustable switch-capacitor power circuit with a plurality of discrete conversion ratios, wherein the adjustable switch-capacitor power circuit comprises an input terminal, a conversion ratio control terminal and an output terminal, and an input voltage is received at the input terminal of the adjustable switch-capacitor power circuit, and an output voltage is outputted at the output terminal of the adjustable switch-capacitor power circuit, and the conversion ratio control terminal receive a conversion ratio signal; comparing, by an error generator, the output voltage with an external reference voltage, to obtain an error voltage; receiving, by a digital controller, the error voltage and outputting a digital control signal; and receiving, by a conversion ratio controller, the digital control signal, and outputting the conversion ratio signal according to the digital control signal, to the conversion ratio control terminal, wherein the adjustable switch-capacitor power circuit uses, according to the conversion ratio signal, one of the plurality of discrete conversion ratios to convert the input voltage into the output voltage.

Preferably, the digital control method further comprises steps of disposing a sampling filter coupled between the output terminal and the error generator, and filtering the output voltage by the sampling filter, wherein the error generator comprises an analog-to-digital conversion component and a subtraction component, and the analog-to-digital conversion component is coupled to the sampling filter and configured to convert the filtered output voltage into a digital output voltage, and the subtraction component is coupled between the analog-to-digital conversion component and the digital controller and configured to subtract the external reference voltage from the digital output voltage, so as to obtain the error voltage.

Preferably, the conversion ratio controller comprises a conversion ratio selection table and a logic control component, and the digital control method comprises steps of determining the conversion ratio signal from the conversion ratio selection table, according to the digital control signal; and transmitting, by the logic control component, the conversion ratio signal to the conversion ratio control terminal.

According to above contents, the digital control system for voltage regulation and a method thereof of the present invention can have at least one of the following advantages.

First, according to above contents, the digital control system for voltage regulation and a method thereof of the present invention can use the digital controller and the conversion ratio controller to output the conversion ratio signal to the adjustable switch-capacitor power circuit for changing the output voltage without adjusting the switching period of the switches, so that the adjustment range of the output voltage is not limited to the switching period of the switches, and the output voltage can be adjusted more stably.

Secondly, the digital control system for voltage regulation and a method thereof of the present invention can digitally adjust the conversion ratio of the adjustable switch-capacitor power circuit, so that the output voltage can be adjusted more simply than the analog control manner.

### BRIEF DESCRIPTION OF THE DRAWINGS

The structure, operating principle and effects of the present invention will be described in detail by way of various embodiments which are illustrated in the accompanying drawings.

FIG. 1 is a block diagram of a digital control system for voltage regulation, according to a first embodiment of the present invention.

FIG. 2 is a circuit diagram of an adjustable switch-capacitor power circuit of a digital control system for voltage regulation, according to a first embodiment of the present invention.

FIG. 3 is a flow chart of operations of the digital control method, according to first embodiment of the present invention.

FIG. 4 is a block diagram of a digital control system for voltage regulation, according to a second embodiment of the present invention.

FIG. 5 is a small-signal analysis circuit diagram of an adjustable switch-capacitor power circuit of a digital control system for voltage regulation, according to a second embodiment of the present invention.

FIG. 6 is a uniform signal analysis circuit diagram of an adjustable switch-capacitor power circuit of a digital control system for voltage regulation, according to second embodiment of the present invention.

FIG. 7 is a z-transformation diagram of a digital controller of a digital control system for voltage regulation, according to a second embodiment of the present invention.

FIG. 8 is a flow chart of a digital control method for voltage regulation, according to a third embodiment of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be understood that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be understood to imply the inclusion of stated elements but not the exclusion of any other elements.

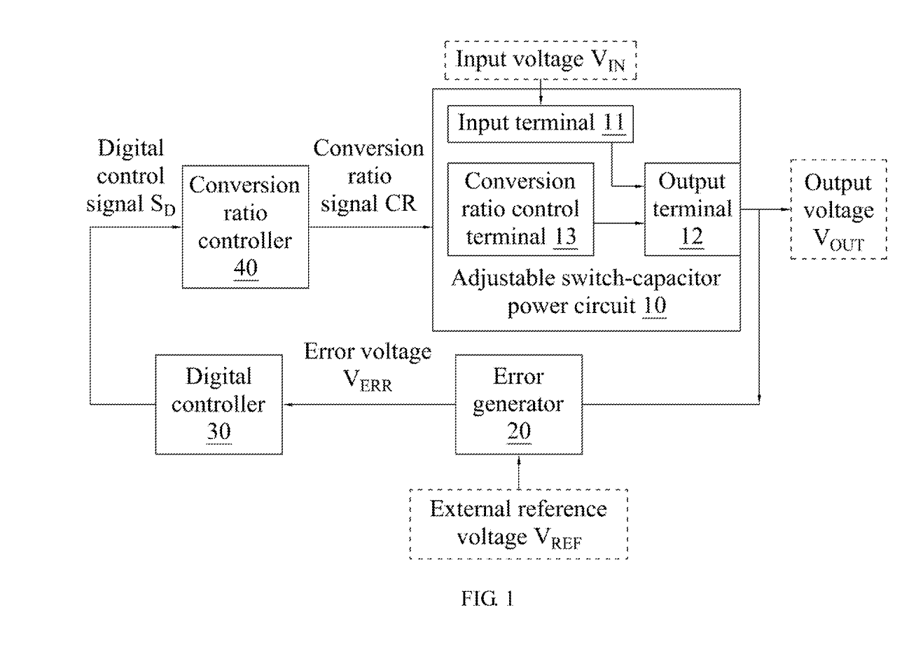

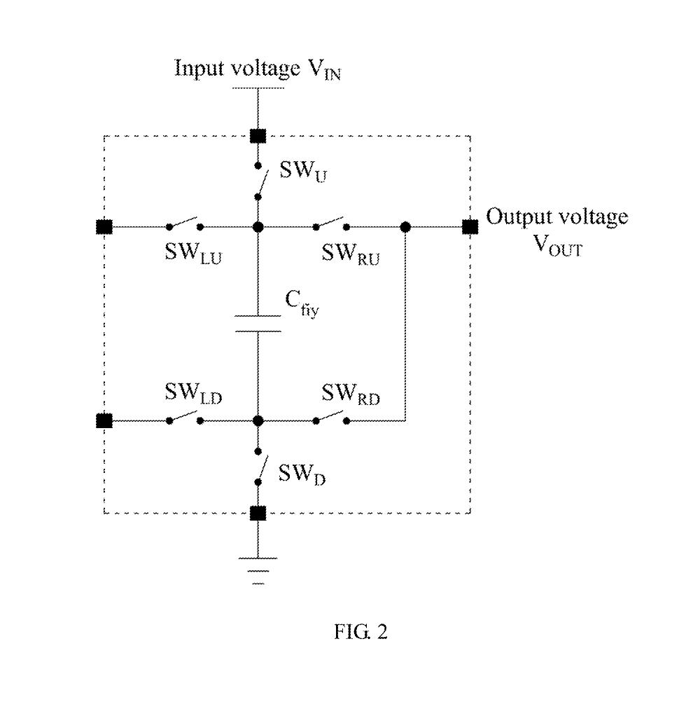

Please refer to FIGS. 1 and 2, which are block diagrams of a digital control system for voltage regulation and circuit diagram of an adjustable switch-capacitor power circuit of the digital control system for voltage regulation, according to a first embodiment of the present invention. In this embodiment, the digital control system for voltage regulation comprises an adjustable switch-capacitor power circuit 10, an error generator 20, a digital controller 30, and a conversion ratio controller 40. The adjustable switch-capacitor power circuit 10 is electrically connected to the error generator 20, and the error generator 20 is electrically connected to the digital controller 30, and the digital controller 30 is electrically connected to the conversion ratio controller 40, and the conversion ratio controller 40 is electrically connected to the adjustable switch-capacitor power circuit 10, so as to form a closed-loop control system for adjusting the output voltage more stably. In the closed-loop control system, the adjustment range of the output voltage can be controlled by a conversion ratio signal CR. Preferably, the adjustable switch-capacitor power circuit 10 can be a fine resolution switch-capacitor power circuit; and, as shown in FIG. 2, the adjustable switch-capacitor power circuit 10 can be formed by a plurality of switches and a plurality of capacitors, and a plurality of adjustable switch-capacitor power circuits 10 can be electrically in series, and an output terminal of one of the plurality of adjustable switch-capacitor power circuits 10 is served as an output terminal 12 of the adjustable switch-capacitor power circuit 10.

It is to be noted that, compared with other switch-capacitor power circuit capable of adjusting output voltage V_{OUT} by several percentage, the fine resolution switch-capacitor power circuit is designed with multiple discrete conversion ratios, and the number of the conversion ratios is so high that the fine resolution switch-capacitor power circuit can adjust the output voltage V_{OUT} more accurately, for example, the fine resolution switch-capacitor power circuit can perform one thousandth of adjustment on the output voltage V_{OUT}, thereby improving accuracy of the output voltage V_{OUT}.

The adjustable switch-capacitor power circuit 10 is designed with a plurality of discrete conversion ratios, and comprises an input terminal 11, a conversion ratio control terminal 13, and the output terminal 12. The input terminal 11 receives an input voltage V_{IN}, the output terminal 12 outputs the output voltage V_{OUT}, and the conversion ratio control terminal 13 receives the conversion ratio signal CR. The adjustable switch-capacitor power circuit 10 can use, according to the conversion ratio signal CR, one of the plurality of discrete conversion ratios, to convert the input voltage V_{IN} into the output voltage V_{OUT}. The error generator 20 is electrically connected to the output terminal 12, and compares the output voltage V_{OUT} with an external reference voltage V_{REF}, to obtain an error voltage V_{ERR}. In this case, the error voltage V_{ERR} is a digital voltage, and the error voltage V_{ERR} is transmitted to the digital controller 30.

The digital controller 30 outputs a digital control signal S_{D} according to the received error voltage V_{ERR}, and transmits the digital control signal S_{D} to the conversion ratio controller 40. The conversion ratio controller 40 can output the conversion ratio signal CR according to the received digital control signal S_{D}, to the adjustable switch-capacitor power circuit 10, and the adjustable switch-capacitor power circuit 10 can use, according to the conversion ratio signal CR, one of the plurality of discrete conversion ratios to adjust the output voltage V_{OUT}. As a result, by adjusting the conversion ratio signal CR correspondingly to the external reference voltage V_{REF}, the output voltage V_{OUT} can be adjusted to almost equal to the external reference voltage V_{REF}.

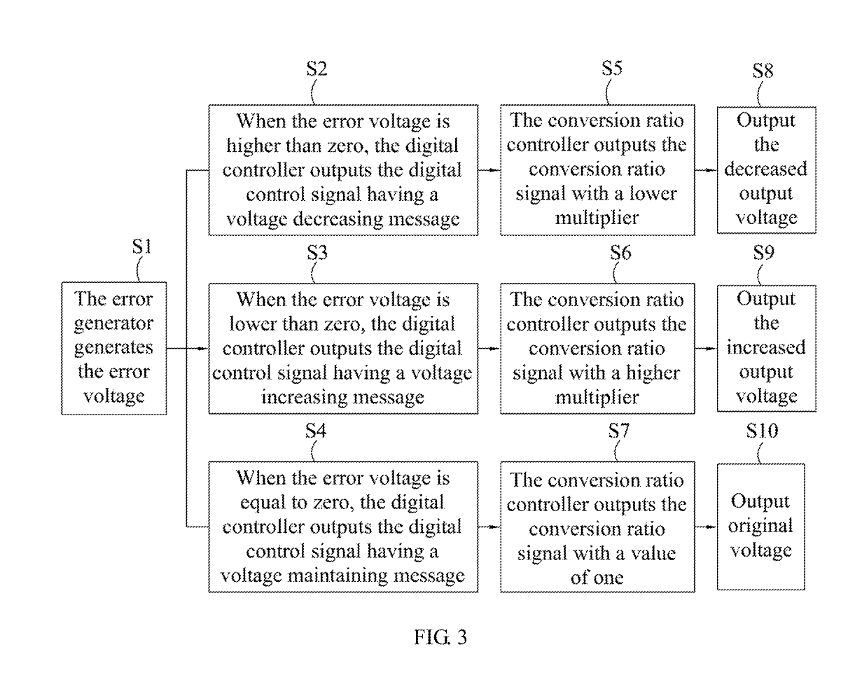

Please refer to FIG. 3, which is a flow chart of an operation of a digital control method for voltage regulation, according to a first embodiment of the present invention. As shown in FIG. 3, the digital control method includes steps S1 to S10. In step S1, the error generator 20 can generate the error voltage V_{ERR}, and one of step S2, step S3 and step S4 is determined to execute according to the value of the error voltage V_{ERR}. Step S2 is executed under a condition that the error voltage V_{ERB} is higher than zero, step S3 is executed under a condition that the error voltage V_{ERB} is lower than zero, and step S4 is executed under a condition that the error voltage V_{ERB} is equal to zero.

In step S2, when the error voltage V_{ERB} is higher than zero, it indicates that the output voltage V_{OUT} is higher than the external reference voltage V_{REF}, and according to the value of the error voltage V_{ERR}, the digital controller 30 outputs the digital control signal S_{D} having a voltage decreasing message M_{S}, and step S5 is then executed.

In step S3, when the error voltage V_{ERR} is lower than zero, it indicates that the output voltage V_{OUT} is lower than the external reference voltage V_{REF}, and according to the value of the error voltage V_{ERR}, the digital controller 30 outputs the digital control signal S_{D} having a voltage increasing message M_{L}, and the step S6 is then executed.

In step S4, when the error voltage V_{ERR} is equal to zero, it indicates that the output voltage V_{OUT} is equal to external reference voltage V_{REF}, and, according to the value of the error voltage V_{ERR}, the digital controller 30 outputs the digital control signal S_{D} having a voltage maintaining message M_{K}, and the step S7 is then executed.

In step S5, according to the digital control signal S_{D} having the voltage decreasing message M_{S}, the conversion ratio controller 40 outputs the conversion ratio signal CR with a lower multiplier S, to the conversion ratio control terminal 13, and step S8 is then executed.

In step S6, according to the digital control signal S_{D} having the voltage increasing message M_{L}, the conversion ratio controller 40 outputs the conversion ratio signal CR with a higher multiplier L, to the conversion ratio control terminal 13, and step S9 is then executed.

In step S7, the conversion ratio controller 40 outputs the conversion ratio signal CR with a value of one, to the conversion ratio control terminal 13, and step S10 is then executed.

In step S8, according to the conversion ratio signal CR with the lower multiplier S, the adjustable switch-capacitor power circuit 10 uses the conversion ratio with a value lower than one, to decrease the output voltage V_{OUT}, and the output terminal 12 outputs the decreased output voltage V_{OUT}.

In step S9, according to the conversion ratio signal CR with the higher multiplier L, the adjustable switch-capacitor power circuit 10 uses the conversion ratio with a value higher than one, to increase the output voltage V_{OUT}, and the increased output voltage V_{OUT} is outputted at the output terminal 12.

In step S10, the adjustable switch-capacitor power circuit 10 does not change the output voltage V_{OUT} according to the conversion ratio signal CR with a value of one, and the original output voltage V_{OUT} is outputted at the output terminal 12.

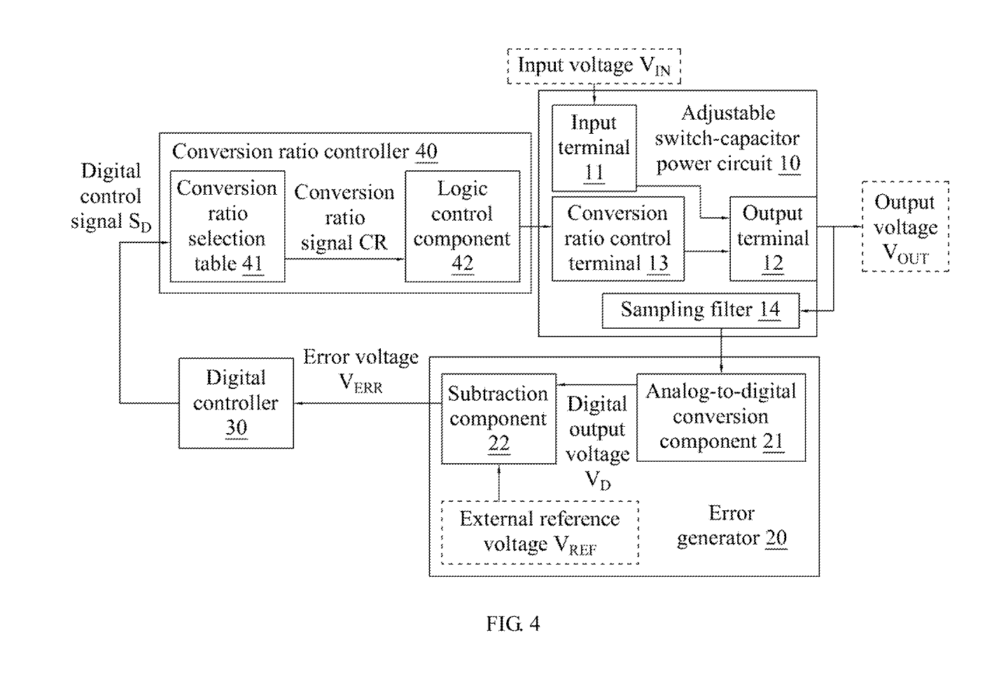

Please refer to FIGS. 4, 5, 6, and 7, which are block diagram of a digital control system for voltage regulation, small-signal analysis circuit diagram of an adjustable switch-capacitor power circuit, uniform signal analysis circuit diagram of an adjustable switch-capacitor power circuit, and z-transformation of a digital controller, according to a second embodiment of the present invention, respectively. In this embodiment, like reference numerals designate like elements of previous embodiment, so the detailed descriptions are not repeated; furthermore, the configuration of some components of this embodiment are similar to that of the previous embodiment, so they are omitted in figures of this embodiment.

As shown in FIG. 4, the adjustable switch-capacitor power circuit 10 can comprise a sampling filter 14, and the error generator 20 comprises an analog-to-digital conversion component 21 and a subtraction component 22. The sampling filter 14 is coupled between the output terminal 12 and the error generator 20, the analog-to-digital conversion component 21 is electrically connected behind the sampling filter 14, and the subtraction component 22 is electrically connected between the analog-to-digital conversion component 21 and digital controller 30. The sampling filter 14 is configured to filter the output voltage V_{OUT}, thereby reducing noise interference for sequential processing.

The analog-to-digital conversion component 21 can convert the filtered output voltage V_{OUT} into a digital output voltage V_{D}, and the subtraction component 22 can subtract the external reference voltage V_{REF} from the digital output voltage V_{D}, to obtain the error voltage V_{ERR}. It is to be noted that the manner of comparing the output voltage V_{OUT} and the external reference voltage V_{REF} to obtain the error voltage V_{ERR} can be implemented by other manner, and the present invention is not limited to above-mentioned example.

In an embodiment, the conversion ratio controller 40 can comprise a conversion ratio selection table 41 and a logic control component 42. The conversion ratio selection table 41 is electrically connected to the digital controller 30, and the conversion ratio signal CR corresponding to the received digital control signal S_{D} can be selected from the conversion ratio selection table 41. The logic control component 42 is electrically connected between the conversion ratio selection table 41 and conversion ratio control terminal 13, and processes and transmits the conversion ratio signal CR to the conversion ratio control terminal 13, so that the adjustable switch-capacitor power circuit 10 can increase or decrease the output voltage V_{OUT} according to the conversion ratio signal CR.

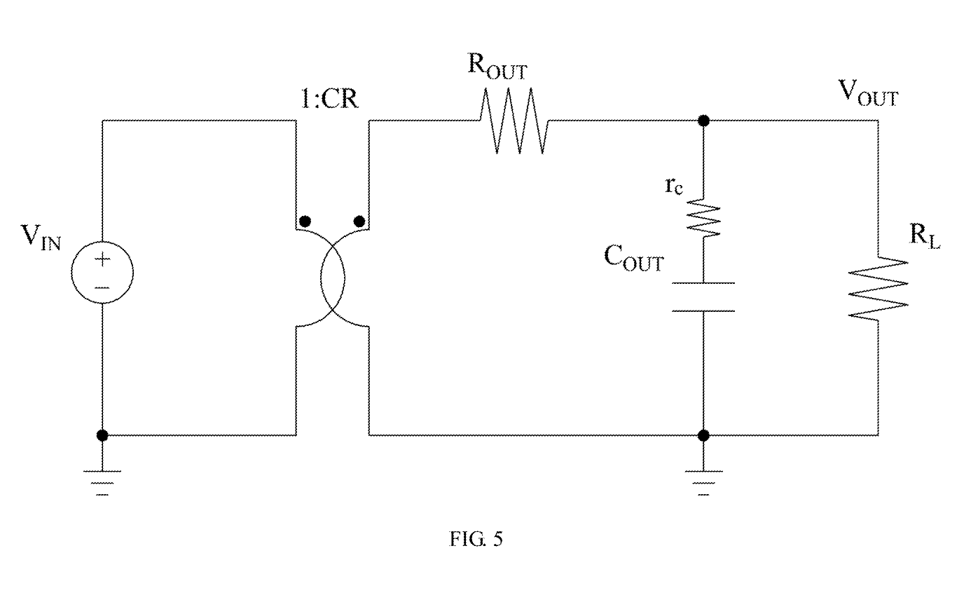

The following describes stability analysis of the digital control system of the present invention. As shown in FIG. 5, a load resistor R_{L} is electrically connected to the adjustable switch-capacitor power circuit 10 for small-signal circuit analysis. When the adjustable switch-capacitor power circuit 10 is stable, the capacitor C_{OUT} acts as open-circuit, and the load resistor R_{L} is electrically connected to the equivalent resistor R_{OUT} of the adjustable switch-capacitor power circuit 10 in series, and a relationship of the input voltage V_{IN} and the output voltage V_{OUT} can be determined by following equation:

V_{OUT}=V_{IN}*CR*(R_{L}/(R_{OUT}+R_{L}))

According to the equation, the load resistor R_{L} and the equivalent resistor R_{OUT} of the adjustable switch-capacitor power circuit 10 are constant, so the output voltage V_{OUT} varies with the conversion ratio signal CR.

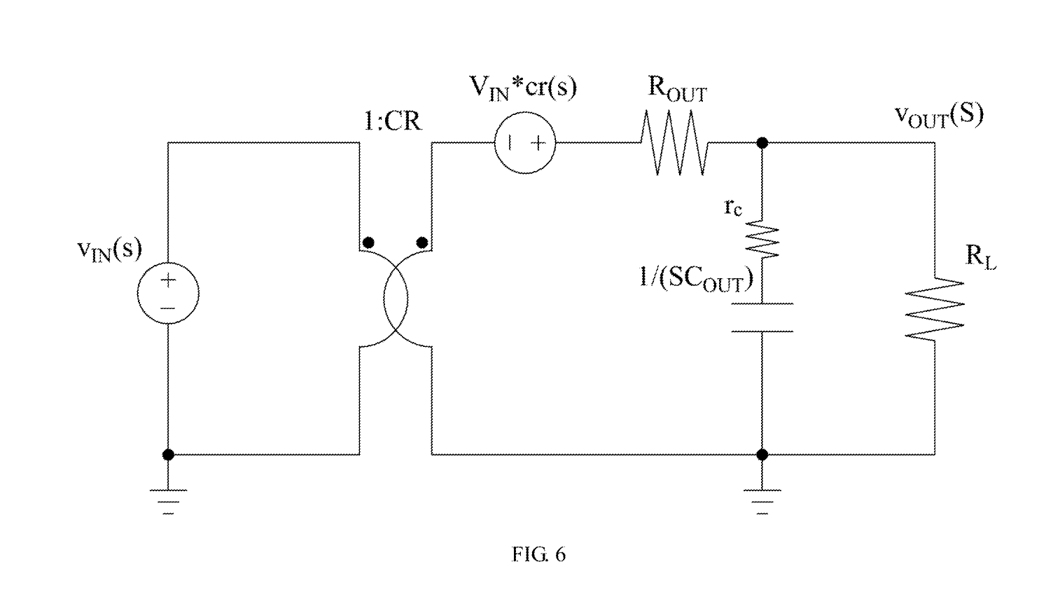

Furthermore, as shown in FIG. 6, in the uniform signal analysis, the input voltage V_{IN}=V_{IN}+v_{IN}(s), the conversion ratio signal CR=CR+cr(s), the output voltage V_{OUT}=vₒᵤₜ(s), and only small signal is considered and the signal with smaller value is ignored, and following equation can be obtained according to FIG. 6:

V_{IN}*CR=V_{IN}*cr(s)+v_{IN}(s)*CR

According to the circuit analysis shown in FIG. 6, the following relationship equations can be obtained:

G_{cr}(s)=(vₒᵤₜ/cr)=V_{IN}*(Z(s)/(Z(s)+R_{OUT}))

Gᵢₒ(s)=(vₒᵤₜ/v_{IN})=CR*(Z(s)/(Z(s)+R_{OUT}))

Z(s)=(r_{c}+(1/sC_{OUT}))//(R_{L})

wherein G_{cr}(s) and Gᵢₒ(s) are transfer functions, G_{cr}(s) is a transfer function of the output voltage vₒᵤₜ(s) and the conversion ratio signal CR, and Gᵢₒ(s) is a transfer function of the output voltage vₒᵤₜ(s) and the input voltage v_{IN}, and the values of the G_{cr}(s) and the Gᵢₒ(s) both are lower than one, so that the adjustable switch-capacitor power circuit 10 can be stable more easily, and the pole of the G_{cr}(s) is C_{OUT}*R_{OUT}, and a zero point of the G_{cr}(s) is r_{c}*C_{OUT}.

The output voltage V_{OUT} across the load resistor RL is inputted into the sampling filter 14, which is formed by resistor and capacitor, so as to filter the noise on the output voltage V_{OUT}.

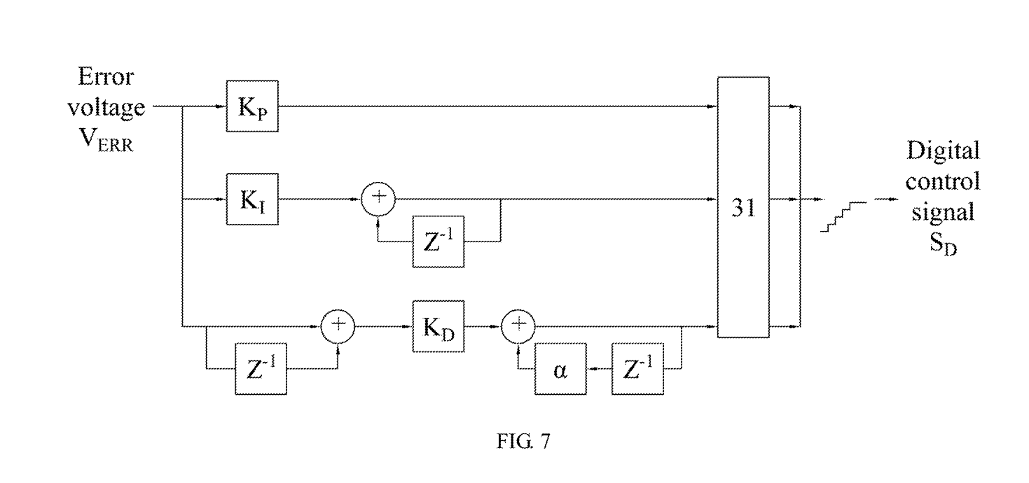

The transfer function G_{cr}(s) has a zero point and a pole, and the output voltage V_{OUT} also has a zero point and a pole, so after z-transformation of the analog-to-digital conversion component 21 and operation of the subtraction component 22 for obtaining the error voltage V_{ERR}, the obtained error voltage V_{ERR} is suitable for the digital controller 30 (such as a proportional-integral-derivative controller (PID controller) shown in FIG. 7) to obtain the digital control signal S_{D}. The transfer function G_{PID}(z) of the PID controller is shown below:

G_{PID}(z)=Kₚ+K_{I}*(1/(1−z⁻¹))+K_{D}*((1−z⁻²)/(1−αz⁻²))

wherein K_{P} is a proportional parameter, K_{I} is an proportional-integral parameter, K_{D} is a proportional-derivative parameter, and the error voltage V_{ERR} is processed based on the proportional parameter K_{P}, the proportional-integral parameter K_{I}, and proportional-derivative parameter K_{D} to obtain three values, respectively. The LSB alignment component 31 can perform alignment on least significant bit (LSB) of the three values, respectively, to make the references of the three values consistent, and integrate the three values to obtain the digital control signal S_{D}, and the conversion ratio signal CR is selected according to the digital control signal S_{D}.

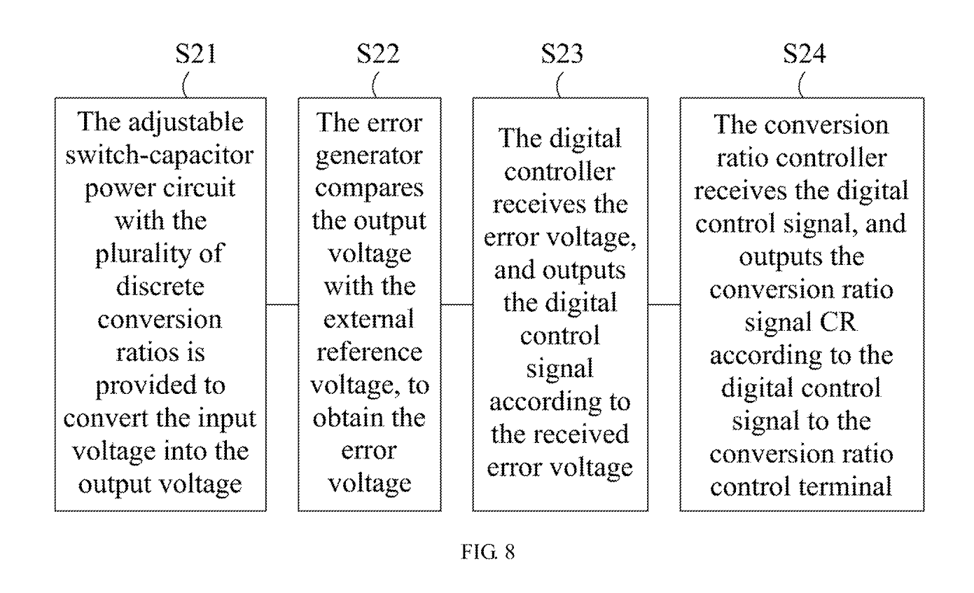

As shown in FIG. 8, which is a flow chart of a digital control method for voltage regulation, according to a third embodiment of the present invention. In this embodiment, like reference numerals designate like elements of previous embodiment, so the detailed descriptions are not repeated; furthermore, the configurations of some components of this embodiment are similar to the previous embodiment, so they are omitted in figures of this embodiment.

As shown in FIG. 8, the digital control method for voltage regulation can be performed by aforementioned digital control system for voltage regulation, and includes steps S21 to S24. In step S21, an adjustable switch-capacitor power circuit 10 with the plurality of discrete conversion ratios is provided, and the adjustable switch-capacitor power circuit 10 has the input terminal 11, the conversion ratio control terminal 13 and the output terminal 12. The input terminal 11 receives the input voltage V_{IN}, the output terminal 12 outputs the output voltage V_{OUT}, and the conversion ratio control terminal 13 receives the conversion ratio signal CR.

In step S22, the error generator 20 compares the output voltage V_{OUT} with the external reference voltage V_{REF}, to obtain the error voltage V_{ERR}. In this case, the error voltage V_{ERR} is a digital voltage indicating the difference between the output voltage V_{OUT} and the external reference voltage V_{REF}.

In step S23, the digital controller 30 receives the error voltage V_{ERR}, and outputs the digital control signal S_{D} according to the received error voltage V_{ERR}. In step S24, the conversion ratio controller 40 receives the digital control signal S_{D}, and outputs the conversion ratio signal CR according to the digital control signal S_{D} to the conversion ratio control terminal 13, and the adjustable switch-capacitor power circuit 10 can use, according to the conversion ratio signal CR, one of the plurality of discrete conversion ratios, to convert the input voltage V_{IN} into the output voltage V_{OUT} outputted at the output terminal 12. As a result, the output voltage V_{OUT} can be adjusted to be almost the same as the external reference voltage V_{REF}. Furthermore, the digital control method for voltage regulation of the present invention can be applied to other regulator, to enable the regulator to provide the output voltage more stably.

Preferably, the digital control system of the present invention can include the sampling filter 14 disposed between the output terminal 12 and the error generator 20 for filtering the output voltage V_{OUT}. The error generator 20 can comprise the analog-to-digital conversion component 21 and the subtraction component 22. The analog-to-digital conversion component 21 is electrically connected to the sampling filter 14 and configured to convert the filtered output voltage V_{OUT} into the digital output voltage V_{D}. The subtraction component 22 subtracts the external reference voltage V_{REF} from the digital output voltage V_{D} to obtain the error voltage V_{ERR}. Furthermore, the conversion ratio controller 40 can comprise the conversion ratio selection table 41 and the logic control component 42. The conversion ratio signal CR can be selected from the conversion ratio selection table 41 according to the digital control signal S_{D}, and the conversion ratio signal CR can be transmitted to the conversion ratio control terminal 13 through the logic control component 42.

In summary, in the digital control system for voltage regulation and the method thereof according to the present invention, the error generator 20, the digital controller 30 and the conversion ratio controller 40 are in cooperation with each other to output the conversion ratio signal CR, and one of the plurality of discrete conversion ratios of the adjustable switch-capacitor power circuit 10 is used, according to the conversion ratio signal CR, to adjust the output voltage V_{OUT} without controlling the switching periods of the switches, so as to increase or decrease the output voltage V_{OUT}; furthermore, the digital manner of controlling the conversion ratio can be simpler than convention the analog manner, and the sampling filter 14 can filter the output voltage V_{OUT} to reduce noise interference. As a result, the digital control system and the method thereof of the present invention can have aforementioned advantages, and is not limited by the switching period of the switches, and can select the conversion ratio according to the conversion ratio signal CR, to control the output voltage V_{OUT}.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A digital control system for voltage regulation, comprising:
an adjustable switch-capacitor power circuit with a plurality of discrete conversion ratios, comprising an input terminal, a conversion ratio control terminal, and an output terminal, wherein the input terminal is configured to receive an input voltage, the output terminal is configured to output an output voltage, the conversion ratio control terminal is configured to receive a conversion ratio signal, and the adjustable switch-capacitor power circuit uses one of the plurality of discrete conversion ratios according to the conversion ratio signal, to convert the input voltage into the output voltage;
an error generator coupled to the output terminal, and configured to compare the output voltage and the external reference voltage, to obtain an error voltage;
a digital controller coupled to the error generator, and configured to receive the error voltage and output a digital control signal; and
a conversion ratio controller coupled between the adjustable switch-capacitor power circuit and digital controller, and configured to receive the digital control signal, and output the conversion ratio signal according to the digital control signal, to the adjustable switch-capacitor power circuit.

2. The digital control system according to claim 1, wherein the adjustable switch-capacitor power circuit is the fine resolution switch-capacitor power circuit.

3. The digital control system according to claim 1, wherein when the error voltage is higher than zero, the digital controller outputs, according to the error voltage, a digital control signal having a voltage decreasing message, and the conversion ratio controller outputs, according to the digital control signal having the voltage decreasing message, the conversion ratio signal with a lower multiplier.

4. The digital control system according to claim 1, wherein when the error voltage is lower than zero, the digital controller outputs, according to the error voltage, the digital control signal having a voltage increasing message, and the conversion ratio controller outputs, according to the digital control signal having the voltage increasing message, the conversion ratio signal with a higher multiplier.

5. The digital control system according to claim 1, wherein when the error voltage is equal to zero, the digital controller outputs the digital control signal having a voltage maintaining message, and the conversion ratio controller outputs the conversion ratio signal with a value of one.

6. The digital control system according to claim 1, wherein the adjustable switch-capacitor power circuit comprises a sampling filter coupled between the output terminal and the error generator and configured to filter the output voltage.

7. The digital control system according to claim 6, wherein the error generator comprises an analog-to-digital conversion component and a subtraction component, and the analog-to-digital conversion component is coupled to the sampling filter and configured to convert the filtered output voltage into a digital output voltage, and the subtraction component is coupled between the analog-to-digital conversion component and the digital controller, and configured to subtract the external reference voltage from the digital output voltage, so as to obtain the error voltage.

8. The digital control system according to claim 1, wherein the conversion ratio controller comprises a conversion ratio selection table and a logic control component, and the conversion ratio signal is determined from the conversion ratio selection table according to the digital control signal, and the logic control component is coupled between the conversion ratio selection table and the conversion ratio control terminal, and configured to transmit the conversion ratio signal to the conversion ratio control terminal.

9. A digital control method for voltage regulation, comprising:
providing an adjustable switch-capacitor power circuit with a plurality of discrete conversion ratios, wherein the adjustable switch-capacitor power circuit comprises an input terminal, a conversion ratio control terminal and an output terminal, and an input voltage is received at the input terminal of the adjustable switch-capacitor power circuit, and an output voltage is outputted at the output terminal of the adjustable switch-capacitor power circuit, and the conversion ratio control terminal receive a conversion ratio signal;
comparing, by an error generator, the output voltage with an external reference voltage, to obtain an error voltage;
receiving, by a digital controller, the error voltage and outputting a digital control signal; and
receiving, by a conversion ratio controller, the digital control signal, and outputting the conversion ratio signal according to the digital control signal, to the conversion ratio control terminal, wherein the adjustable switch-capacitor power circuit uses, according to the conversion ratio signal, one of the plurality of discrete conversion ratios to convert the input voltage into the output voltage.

10. The digital control method according to claim 9, wherein the conversion ratio controller comprises a conversion ratio selection table and a logic control component, and the digital control method comprises:
determining the conversion ratio signal from the conversion ratio selection table, according to the digital control signal; and
transmitting, by the logic control component, the conversion ratio signal to the conversion ratio control terminal.
